(19) United States
(12) Patent Application Publication
(10) Pub. No.: US 2025/0196322 A1
(43) Pub. Date: Jun. 19, 2025

(54) ASSEMBLY-TYPE STRUCTURE FOR FIXING MOTOR AND EXERCISE ASSISTANCE DEVICE INCLUDING SAME

(71) Applicant: Samsung Electronics Co., Ltd., Suwon-si (KR)

(72) Inventors: Huu Lam Vuong NGUYEN, Suwon-si (KR); Bola PARK, Suwon-si (KR); Namki SUL, Suwon-si (KR); Juseon AN, Suwon-si (KR); Wonjun CHOI, Suwon-si (KR)

(21) Appl. No.: 19/064,361

(22) Filed: Feb. 26, 2025

Related U.S. Application Data
(63) Continuation of application No. PCT/KR2023/009451, filed on Jul. 5, 2023.

(30) Foreign Application Priority Data
Sep. 1, 2022 (KR) 10-2022-0110507
Oct. 17, 2022 (KR) 10-2022-0133328

(51) Int. Cl. B25J 9/00; A61H 3/00

(52) U.S. Cl. CPC B25J 9/0009; A61H 3/00; B25J 9/0006

(57) ABSTRACT

An assembly-type structure for fixing a motor of a wearable device may include: an upper frame and a lower frame that support a proximal part of a user and face each other in parallel; an upper holder that is connected to the upper frame; a lower holder that is connected to the lower frame; a main holder that is provided between the upper frame and the lower frame and supported by the upper holder and the lower holder; and a motor that is connected to the main holder.

### CROSS-REFERENCE TO RELATED APPLICATIONS

This application is a continuation application of International Application No. PCT/KR2023/009451 designating the United States, filed on Jul. 5, 2023, in the Korean Intellectual Property Receiving Office and claiming priority to Korean Patent Application No. 10-2022-0110507, filed on Sep. 1, 2022, and Korean Patent Application No. 10-2022-0133328, filed on Oct. 17, 2022, the disclosures of which are all hereby incorporated by reference herein in their entireties.

### BACKGROUND

### Technical Field

Certain example embodiments may relate to an assembly-type motor fixing structure and/or an exercise assistance device including the same.

### Description of Related Art

In a rapidly aging society, a growing number of people are complaining of joint-related inconvenience and pain. Accordingly, there is a heightened interest in an assistance device for assisting the elderly or patients having joint problems, and/or to assist users with exercise. An exercise assistance device, such as a walking assist device, may also be worn to increase the muscular strength of a certain body part.

### SUMMARY

According to an example embodiment, an assembly-type motor fixing structure may include an upper frame and a lower frame configured to support the proximal part of a user and provided side by side facing each other, an upper holder connected to the upper frame, a lower holder connected to the lower frame, a main holder provided between at least the upper frame and the lower frame and supported by the upper holder and the lower holder, and a motor connected to the main holder.

According to an example embodiment, an exercise assistance device may include an assembly-type motor fixing structure which may include a waist belt configured to support the proximal part of a user and including an upper frame and a lower frame provided side by side facing each other, a thigh belt configured to support the distal part of the user, an actuator connected to the waist belt and including a motor configured to generate power, a driving frame configured to transmit power from the actuator to the thigh belt, an upper holder connected to the upper frame, a lower holder connected to the lower frame, and a main holder supported by the upper holder and the lower holder and connected to the actuator.

### BRIEF DESCRIPTION OF DRAWINGS

FIG. 1 is a perspective view illustrating a user wearing an exercise assistance device, according to an example embodiment.

FIG. 2 is a perspective view illustrating an upper frame, a lower frame, an upper holder, a lower holder, a main holder, a motor, and a belt holder, according to an example embodiment.

FIG. 3 is an exploded perspective view illustrating an upper holder, a lower holder, a main holder, and a motor, according to an example embodiment.

FIG. 4 is a rear view illustrating an upper holder, a lower holder, a main holder, a motor, and a belt holder, according to an example embodiment.

FIG. 5 is an exploded perspective view illustrating a main holder and a motor, according to an example embodiment.

FIG. 6 is a perspective view illustrating a main holder and a motor formed integrally as one body, according to another example embodiment.

### DETAILED DESCRIPTION

The following detailed structural or functional description is provided as an example only and various alterations and modifications may be made to example embodiments. Accordingly, the embodiments are not to be construed as limited to the disclosure and should be understood to include all changes, equivalents, or replacements within the idea and the technical scope of the disclosure.

Terms, such as first, second, and the like, may be used herein to describe various components. Each of these terms is not used to define an essence, order or sequence of a corresponding component but is used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component may be “connected”, “coupled”, and “joined” between the first and second components, although the first component may be directly connected, coupled, or joined to the second component. Thus, “connect” and “connected” for example as used herein cover both direct and indirect connections.

The singular forms “a”, “an”, and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

The same name may be used to describe an element included in the embodiments described above and an element having a function in common. Unless stated otherwise, the description of an embodiment may be applicable to other embodiments, and a repeated description related thereto is omitted.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

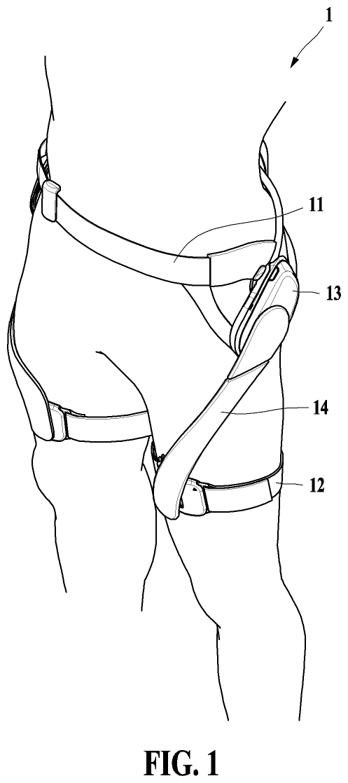

FIG. 1 is a perspective view illustrating a user wearing an exercise assistance device, according to an embodiment.

Referring to FIG. 1, according to an embodiment, an exercise assistance device 1 may be worn by a user and assist the motion of the user. The user may be a human, an animal, or a robot but is not limited thereto. The exercise assistance device 1 may assist the motion of some lower body joints of the user. For example, the exercise assistance device 1 may assist the motion of the lower body of the user by assisting at least one of a hip joint, a knee joint, and an ankle joint of the user. The exercise assistance device 1 may assist the user in walking by assisting the motion of some lower body joints of the user. Hereinafter, the description is provided based on the exercise assistance device 1 assisting the user in walking by assisting the motion of the hip joint of the user, but a wearing part and a target joint of the exercise assistance device 1 are not limited thereto. The exercise assistance device 1 may include a proximal support 11, a distal support 12, an actuator 13, and a driving frame 14.

In an embodiment, the proximal support 11 and the distal support 12 may be disposed opposite to each other based on the body part of the user and may respectively support the proximal part and the distal part. For example, the proximal support 11 may support the waist and/or the pelvis of the user and the distal support 12 may support the thigh, the knee, the calf, and/or the foot of the user. The proximal support 11 may include a detachable belt for supporting the waist of the user all around. The proximal support 11 may include a waist belt. The distal support 12 may include a detachable belt for supporting the thigh of the user all around. The distal support 12 may include a thigh belt.

In an embodiment, the proximal support 11 and the distal support 12 may move relative to each other on a sagittal plane. For example, in the case of hip joint flexion or extension while the user wears the exercise assistance device 1, the distal support 12 may rotate relative to the proximal support 11 on the sagittal plane.

In an embodiment, the proximal support 11 and the distal support 12 may move relative to each other on a frontal plane. For example, in the case of hip joint adduction or abduction while the user wears the exercise assistance device 1, the distal support 12 may rotate relative to the proximal support 11 on the frontal plane.

In an embodiment, the driving frame 14 and the distal support 12 may move relative to each other on a transverse plane. For example, when the user rotates their thigh while wearing the exercise assistance device 1, the distal support 12 may rotate together with the thigh of the user while being in close contact with the thigh. That is, the distal support 12 may rotate relative to the driving frame 14. According to this structure, the wearability of the exercise assistance device 1 may be improved.

In an embodiment, the actuator 13 may be connected to the proximal support 11 and may generate power. The actuator 13 may include, for example, a motor and a speed reducer. The motor may include at least one of a brush motor, a brushless motor, and a stepping motor. The motor may include at least one of an induction motor and a synchronous motor. The speed reducer may include, for example, a gear train.

In an embodiment, the driving frame 14 may transmit power generated by the actuator 13 to the distal support 12. For example, the driving frame 14 may assist the motion of the hip joint of the user. When an output terminal of the actuator 13 rotates in one direction, the driving frame 14 may receive power from the actuator 13 and assist flexion of the hip joint of the user. When the output terminal of the actuator 13 rotates in a direction that is opposite to the one direction, the driving frame 14 may receive power from the actuator 13 and assist extension of the hip joint of the user.

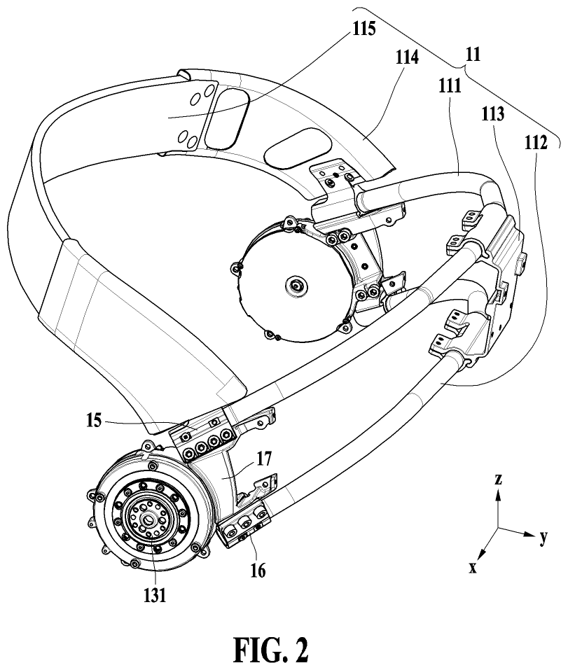

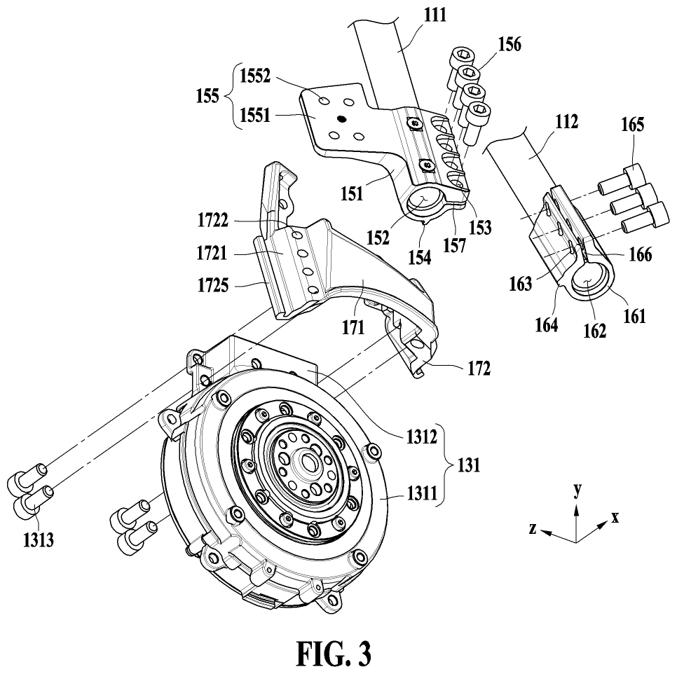

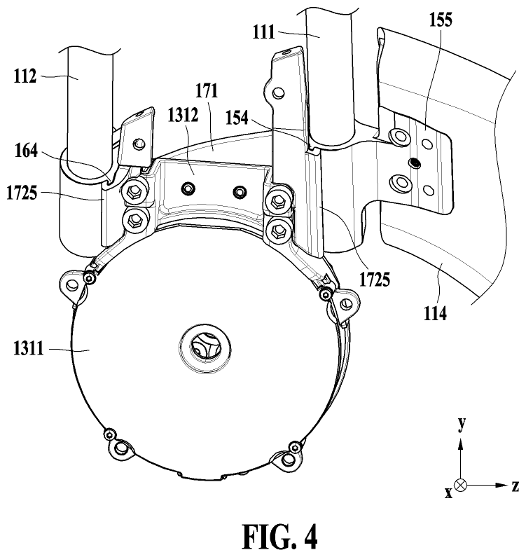

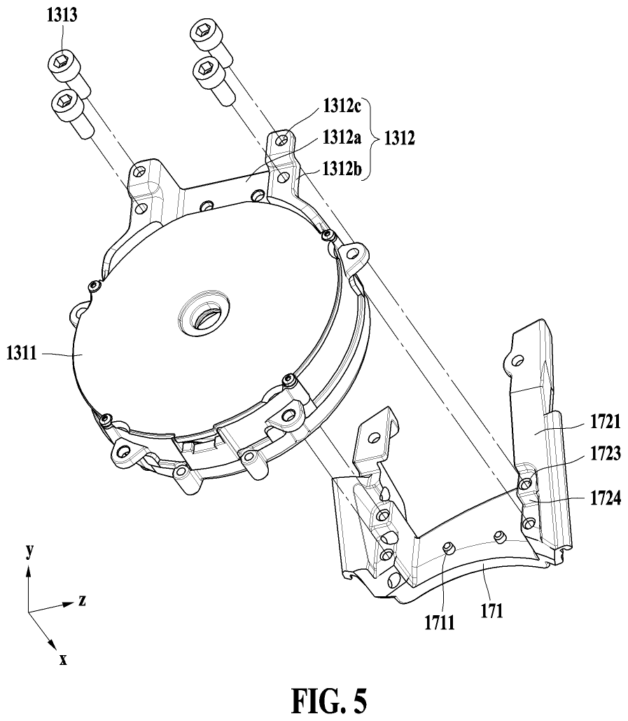

FIG. 2 is a perspective view illustrating an upper frame, a lower frame, an upper holder, a lower holder, a main holder, a motor, and a belt holder, according to an embodiment, FIG. 3 is an exploded perspective view illustrating an upper holder, a lower holder, a main holder, and a motor, according to an embodiment, FIG. 4 is a rear view illustrating an upper holder, a lower holder, a main holder, a motor, and a belt holder, according to an embodiment, and FIG. 5 is an exploded perspective view illustrating a main holder and a motor, according to an embodiment.

Referring to FIGS. 2 to 5, according to an embodiment, an exercise assistance device may include an assembly-type motor fixing structure. An actuator may be connected to a proximal support through the assembly-type motor fixing structure. Compared to a case in which the actuator is directly coupled to the proximal support, the coupling strength between the actuator and the proximal support may increase. The proximal support 11 may include an upper frame 111, a lower frame 112, a frame holder 113, a belt holder 114, and a belt 115. The actuator may include a motor 131.

In an embodiment, the upper frame 111 and the lower frame 112 may support the proximal part of a user and may be provided side by side facing each other. Among the two frames, the frame positioned higher with respect to the ground may be the upper frame 111. For example, the upper frame 111 and the lower frame 112 may have a shape that is bent along the proximal part of the user. For example, the upper frame 111 and the lower frame 112 may be formed of a lightweight and durable metal, such as aluminum.

In an embodiment, the frame holder 113 may support the upper frame 111 and the lower frame 112. A cushioning material capable of supporting the proximal part of the user may be attached to the frame holder 113.

The upper frame 111 and the lower frame 112 may pass through a through hole formed through the frame holder 113 and be supported by the frame holder 113. For example, the upper frame 111 and the lower frame 112 may each have a symmetrical structure based on the frame holder 113. The wearability of the exercise assistance device may be improved, and safety may be enhanced.

In an embodiment, the belt holder 114 may be connected to the upper frame 111 and may support the belt 115 surrounding the proximal part.

The belt 115 may be detachably connected to the belt holder 114. The user may use a plurality of belts formed of different materials by replacing the plurality of belts depending on the intensity of exercise, purpose, etc.

In an embodiment, an upper holder 15 may be connected to an end portion of the upper frame 111. For example, the upper holder 15 may be provided as a pair and may be connected to both end portions of the upper frame 111. For example, the upper holder 15 may be formed of aluminum. The upper holder 15 may include an upper body 151, an upper main hole 152, an upper connection hole 153, an upper protrusion 154, and an upper plate 155.

In an embodiment, the upper body 151 may surround a portion of the end portion of the upper frame 111. The upper main hole 152 may be formed through the upper body 151, and the upper frame 111 may be inserted into the upper main hole 152. The upper holder 15 may move along the longitudinal direction of the upper frame 111. A hole or a groove may be formed in the upper frame 111. The upper body 151 may include a hole formed in the upper frame 111 or a hole overlapping the groove. From this structure, the upper holder 15 may be screw-coupled to the upper frame 111 at a predetermined position. The coupling strength between the upper holder 15 and the upper frame 111 may increase, and noise due to friction may be improved.

In another embodiment, a hole or groove into which a screw is inserted may not be formed in the upper frame. The upper frame may be pressed as the screw rotates in the fastening direction. The upper frame may be clamped to the upper body. From this structure, the position of the upper holder may be adjusted along the longitudinal direction of the upper frame.

In an embodiment, the upper connection hole 153 may be formed through the upper body 151. For example, the upper connection hole 153 may be provided in plurality along the longitudinal direction of the upper frame 111. An upper screw 156 may pass through the upper connection hole 153 and be coupled to a main holder 17. The upper holder 15 may be connected to the main holder 17.

In an embodiment, when the upper body 151 only partially surrounds the circumference of the upper frame 111, an upper gap 157 may exist in the upper holder 15. The upper gap 157 may be the same as the distance between two end portions of the upper body 151 facing each other. The upper connection hole 153 may be formed through each of the two end portions of the upper body 151 facing each other along the width direction of the upper frame 111. The one upper screw 156 may sequentially pass through the two upper connection holes 153 provided along the width direction of the upper frame 111 and be coupled to the main holder 17. As the upper screw 156 is fastened to the main holder 17, the upper gap 157 may be reduced. The gap between the upper body 151 and the upper frame 111 may be reduced. The coupling strength between the upper holder 15 and the upper frame 111 may increase, and noise due to friction may be improved.

In an embodiment, the upper protrusion 154 may protrude from the upper body 151. For example, the upper protrusion 154 may be provided along the longitudinal direction of the upper body 151. As described below, the upper protrusion 154 may be accommodated in the main holder 17.

In an embodiment, the upper plate 155 may extend from the upper body 151 and may be provided on the opposite side of the upper connection hole 153 based on the upper frame 111. The upper plate 155 may be connected to the belt holder 114. The belt screw 116 may pass through a plate hole 1552 formed through a plate body 1551 and may be coupled to the belt holder 114. The belt holder 114 may be stably coupled to the upper frame 111. Compared to a case in which the belt holder 114 is directly coupled to the upper frame 111, the coupling strength may increase.

In an embodiment, a lower holder 16 may be connected to an end portion of the lower frame 112. The lower holder 16 may include a lower body 161, a lower main hole 162, and a lower connection hole 163. The lower body 161 may surround a portion of the end portion of the lower frame 112. The lower main hole 162 may be formed through the lower body 161, and the lower frame 112 may be inserted into the lower main hole 162. The lower connection hole 163 may be formed through the lower body 161. A lower screw 165 may pass through the lower connection hole 163 and be coupled to the main holder 17. The lower holder 16 may be connected to the main holder 17. The one lower screw 165 may sequentially pass through the two lower connection holes 163 that are provided along the width direction of the lower frame 112 and be coupled to the main holder 17. As the lower screw 165 is fastened to the main holder 17, a lower gap 166 may be reduced. A lower protrusion 164 may protrude from the lower body 161 and be accommodated in the main holder 17.

In addition to the descriptions provided above, unless otherwise specified, the features of the lower holder and the lower frame may be the same as or similar to the features of the upper holder and the upper frame.

In an embodiment, the main holder 17 may connect the motor 131 to the proximal support 11. The main holder 17 may be supported by the upper holder 15 and the lower holder 16. For example, the main holder 17 may be formed of a lightweight and durable metal, such as aluminum. The main holder 17 may include a holder base 171 and a holder side 172.

In an embodiment, the holder base 171 may be provided between the upper holder 15 and the lower holder 16. For example, the holder base 171 may include a curved surface capable of supporting the circumference of the motor 131. From this structure, foreign materials may be prevented or reduced from penetrating the gap between the main holder 17 and the motor 131. Noise and wear of the components due to friction between the motor 131 and the main holder 17 may be reduced.

In an embodiment, the holder side 172 may extend from the holder base 171. The holder side 172 may be provided as a pair facing each other, and each of the pair of holder sides 172 may be supported by the upper holder 15 and the lower holder 16. The pair of holder sides 172 may each include a side body 1721, a holder connection groove 1722, a motor connection groove 1723, and a hook 1725.

In an embodiment, the side body 1721 may be connected to the upper holder 15, the lower holder 16, and the motor 131. Hereinafter, among the pair of side bodies 1721, the description is provided based on the side body that is connected to the upper holder 15.

In an embodiment, the side body 1721 may be provided between the upper holder 15 and the motor 131 and may connect the upper holder 15 to the motor 131. For example, the side body 1721 may include a surface having a shape that is bent along the external shape of the upper body 151 to be supported by the upper body 151. The gap between the upper holder 15 and the main holder 17 may be reduced. Foreign materials may be prevented or reduced from penetrating between the upper holder 15 and the main holder 17. Noise due to friction between the upper holder 15 and the main holder 17 may be improved.

In an embodiment, the holder connection groove 1722 may be recessed in the side body 1721. The holder connection groove 1722 may be provided in the same number as the number of upper connection holes 153, and each of the holder connection grooves 1722 may overlap the upper connection holes 153. The upper screw 156 may be fixed to the holder connection groove 1722 after passing through the upper connection hole 153.

In an embodiment, the motor connection groove 1723 may be recessed in the side body 1721. The motor connection groove 1723 may be formed on the opposite side of the holder connection groove 1722 based on the side body 1721. Based on the side body 1721, the direction in which the upper holder 15 is supported by the main holder 17 may be opposite to the direction in which the motor 131 is supported by the main holder 17.

In an embodiment, the hook 1725 may protrude from the side body 1721. The hook 1725 may be formed on the opposite side of the holder base 171 based on the side body 1721 and may have a bent shape. The gap may exist between the hook 1725 and the side body 1721. The upper protrusion 154 may be positioned between the hook 1725 and the side body 1721. The hook 1725 may cover the upper protrusion 154. From this structure, the relative rotation of the main holder 17 with respect to the upper holder 15 may be limited. The magnitude of the external force applied to the upper screw 156 may be reduced. The main holder 17 may be stably supported by the upper holder 15. The durability of the exercise assistance device may be improved.

In addition to the descriptions provided above, unless otherwise specified, the features of the lower holder 16 and the side body 1721 that is connected to the lower holder 16 may be the same as or similar to the features of the upper holder 15 and the side body 1721 that is connected to the upper holder 15.

In an embodiment, when the upper holder 15, the lower holder 16, or the main holder 17 is damaged or worn due to repeated use of the exercise assistance device, only the damaged or worn components may be separated and replaced. Maintenance and repair costs of the exercise assistance device may be reduced.

In an embodiment, the motor 131 may generate power, and the generated power may be transmitted to a driving frame. The motor 131 may be connected to the main holder 17. The motor 131 may include a motor body 1311 and a motor arm 1312.

In an embodiment, the motor body 1311 may generate power. For example, the motor body 1311 may have a round shape. The motor body 1311 may have a structure that may be disassembled and assembled to replace a stator and a rotor accommodated therein.

In an embodiment, the motor arm 1312 may extend from the motor body 1311 to a space between the upper frame 111 and the lower frame 112. The motor arm 1312 may be connected to the main holder 17. The motor arm 1312 may include an arm base 1312a, an arm side 1312b, and an armhole 1312c.

In an embodiment, the arm base 1312a may be supported by the holder base 171. Two base protrusions 1711 protruding from the holder base 171 may pass through two holes formed through the arm base 1312a, respectively. The relative sliding and rotation of the arm base 1312a with respect to the holder base 171 may be limited. The magnitude of the external force applied to a motor screw 1313 may be reduced.

In an embodiment, the arm side 1312b may extend from the arm base 1312a. The arm side 1312b may be provided as a pair facing each other, and each of the pair of arm sides 1312b may be supported by the holder side 172. Hereinafter, among the pair of arm sides 1312b, the description is provided based on the arm side that is connected to the holder side 172 supporting the upper holder 15.

In an embodiment, the armhole 1312c may be formed through the arm side 1312b. The armhole 1312c may overlap the motor connection groove 1723. The motor screw 1313 may be coupled to the motor connection groove 1723 after passing through the armhole 1312c. The direction in which the motor screw 1313 is coupled to the side body 1721 may be opposite to the direction in which the upper screw 156 is coupled to the side based on the side body 1721. From this structure, the main holder 17 may be positioned between the upper holder 15 and the motor 131 and may firmly connect the upper holder 15 to the motor 131.

In an embodiment, the armhole 1312c and the motor connection groove 1723 may be provided in plurality. The holder side 172 may include a step 1724 provided between the two adjacent holder connection grooves 1722 among the plurality of holder connection grooves 1722. The arm side 1312b may include a step to be supported by the holder side 172. From this structure, the relative sliding of the arm side 1312b with respect to the holder side 172 may be limited. The external force applied to the motor screw 1313 that is coupled to the side body 1721 may be reduced. The motor 131 may be stably supported by the main holder 17.

In an embodiment, the assembly-type motor fixing structure may dissipate heat generated from the motor into the upper frame 111 and the lower frame 112. When the exercise assistance device is used for a long time, the motor may be heated. For example, as described above, the main holder 17, the upper holder 15, and the lower holder 16 may be formed of aluminum having high thermal conductivity. Heat generated from the motor 131 may be conducted to the main holder 17. The main holder 17 may conduct heat to the upper frame 111 and the lower frame 112 through the upper holder 15 and the lower holder 16, respectively. Deformation and damage to the exercise assistance device caused by heating of the motor may be reduced.

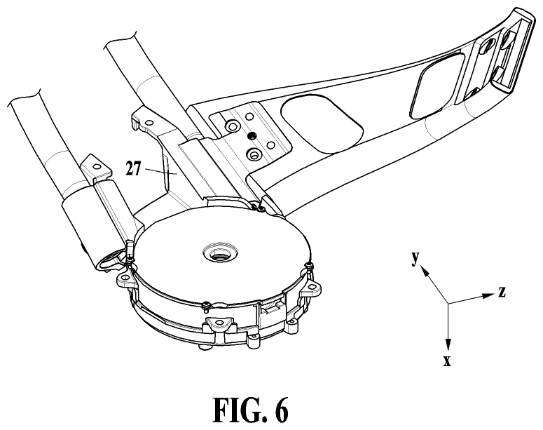

FIG. 6 is a perspective view illustrating a main holder and a motor formed integrally as one body, according to another embodiment.

Referring to FIG. 6, according to another embodiment, a main holder and a motor may be formed integrally as one body. An integrated main holder and motor 27 may be supported by an upper holder and a lower holder. An assembly-type motor fixing structure may be simplified. The production process of the assembly-type motor fixing structure may be simplified, and the production cost may be reduced. Heat generated from the motor may be directly conducted to the upper holder and the lower holder. Heat dissipation may be achieved efficiently.

In another embodiment, the main holder and the lower holder may be formed integrally as one body. The degree of damage or wear of the lower holder may be less than that of the upper holder supporting a belt. The replacement cycle of the lower holder may be longer than that of the upper holder. Since the lower holder is formed integrally with the main holder, the process of connecting the lower holder to the main holder may be omitted, and the assembly process of the motor fixing structure may be simplified. The management of individual parts may be facilitated.

An assembly-type motor fixing structure, according to an embodiment, may include an upper frame and a lower frame configured to support the proximal part of a user and provided side by side facing each other, an upper holder connected, directly or indirectly, to the upper frame, a lower holder connected, directly or indirectly, to the lower frame, a main holder provided between the upper frame and the lower frame and supported by the upper holder and the lower holder, and a motor connected, directly or indirectly, to the main holder.

In an embodiment, the main holder may include a holder base provided between the upper holder and the lower holder, and a holder side extending from the holder base and supported by the upper holder and the lower holder.

In an embodiment, the holder side may include a side body, a motor connection groove recessed in the side body, and a holder connection groove recessed in the side body and formed on the opposite side of the motor connection groove based on the side body.

In an embodiment, the upper holder may include an upper body capable of surrounding a portion of the upper frame, an upper main hole formed through the upper body and into which the upper frame is capable of being inserted, an upper connection hole formed through the upper body and overlapping the holder connection groove, and an upper plate provided on the opposite side of the upper connection hole based on the upper frame and extending from the upper body.

In an embodiment, the upper holder may further include an upper protrusion protruding from the upper body.

In an embodiment, one holder side of the pair of holder sides may further include a hook protruding from the side body and surrounding the upper protrusion.

In an embodiment, the lower holder may include a lower body capable of surrounding a portion of the lower frame, a lower main hole formed through the lower body and into which the lower frame is capable of being inserted, and a lower connection hole formed through the lower body and overlapping the holder connection groove.

In an embodiment, the lower holder may further include a lower protrusion protruding from the lower body.

In an embodiment, the motor may include a motor body configured to transmit power and a motor arm extending from the motor body to a space between the upper frame and the lower frame and connected, directly or indirectly, to the main holder.

In an embodiment, the motor arm may include an arm base supported by the holder base, a pair of arm sides extending from the arm base and supported by the pair of holder sides, and an armhole formed through the pair of arm sides and overlapping the holder connection groove.

In an embodiment, the holder connection groove may be formed in plurality in the side body, and the holder side may include a step provided between two adjacent connection grooves among the plurality of holder connection grooves.

In an embodiment, one of the upper holder, the lower holder, and the main holder may be formed of aluminum.

In an embodiment, the main holder and the motor may be formed integrally as one body.

In an embodiment, the main holder and the lower holder may be formed integrally as one body.

An exercise assistance device including an assembly-type motor fixing structure, according to an embodiment, may include a proximal support configured to support the proximal part of a user and including an upper frame and a lower frame provided side by side facing each other, a distal support configured to support the distal part of the user, an actuator connected, directly or indirectly, to the proximal support and including a motor configured to generate power, a driving frame configured to transmit power from the actuator to the distal support, an upper holder connected, directly or indirectly, to the upper frame, a lower holder connected, directly or indirectly, to the lower frame, and a main holder supported by the upper holder and the lower holder and connected, directly or indirectly, to the actuator. “Supported by” as used herein covers both directly supported by and indirectly supported by with other element(s) therebetween.

In an embodiment, the main holder may include a holder base provided between the upper holder and the lower holder, and a holder side extending from the holder base and supported by the upper holder and the lower holder.

In an embodiment, the holder side may include a side body, a motor connection groove recessed in the side body, and a holder connection groove recessed in the side body and formed on the opposite side of the motor connection groove based on the side body.

In an embodiment, the upper holder may include an upper body capable of surrounding a portion of the upper frame, an upper main hole formed through the upper body and into which the upper frame is capable of being inserted, an upper connection hole formed through the upper body and overlapping the holder connection groove, and an upper plate provided on the opposite side of the upper connection hole based on the upper frame and extending from the upper body.

In an embodiment, the lower holder may include a lower body capable of surrounding a portion of the lower frame, a lower main hole formed through the lower body and into which the lower frame is capable of being inserted, and a lower connection hole formed through the lower body and overlapping the holder connection groove.

The features of the embodiments described above may be combined unless clearly technically impossible.

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

1. An assembly-type motor fixing structure of a wearable device, comprising:
an upper frame and a lower frame configured to support a proximal part of a user of the wearable device, and provided side by side facing each other;
an upper holder connected to the upper frame;
a lower holder connected to the lower frame;
a main holder provided between at least the upper frame and the lower frame, and supported by the upper holder and the lower holder; and
a motor connected to the main holder.

2. The assembly-type motor fixing structure of claim 1, wherein the main holder comprises:
a holder base provided between at least the upper holder and the lower holder;
a holder side extending from the holder base and supported by the upper holder and/or the lower holder.

3. The assembly-type motor fixing structure of claim 2, wherein the holder side comprises:
a side body;
a motor connection groove recessed in the side body; and
a holder connection groove recessed in the side body and formed on an opposite side of the motor connection groove based on the side body.

4. The assembly-type motor fixing structure of claim 3, wherein the upper holder comprises:
an upper body configured for surrounding a portion of the upper frame;
an upper main hole formed through the upper body and into which the upper frame is configured to be inserted;
an upper connection hole formed through the upper body and overlapping the holder connection groove; and
an upper plate provided on an opposite side of the upper connection hole based on the upper frame and extending from the upper body.

5. The assembly-type motor fixing structure of claim 4, wherein the upper holder further comprises an upper protrusion protruding from the upper body.

6. The assembly-type motor fixing structure of claim 5, wherein at least one holder side of pair of holder sides further comprises a hook protruding from the side body and surrounding the upper protrusion.

7. The assembly-type motor fixing structure of claim 3, wherein the lower holder comprises:
a lower body configured for at least partially surrounding a portion of the lower frame;
a lower main hole formed through the lower body and into which the lower frame is to be inserted; and
a lower connection hole formed through the lower body and overlapping the holder connection groove.

8. The assembly-type motor fixing structure of claim 7, the lower holder further comprises a lower protrusion protruding from the lower body.

9. The assembly-type motor fixing structure of claim 3, wherein the motor comprises:
a motor body configured to transmit power; and
a motor arm extending from the motor body to a space between at least the upper frame and the lower frame and connected to the main holder.

10. The assembly-type motor fixing structure of claim 9, wherein the motor arm comprises:
an arm base supported by the holder base;
a pair of arm sides extending from the arm base and supported by pair of holder sides; and
an armhole formed through the pair of arm sides and overlapping the holder connection groove.

11. The assembly-type motor fixing structure of claim 10, wherein
the holder connection groove is formed in plurality in the side body,
the holder side comprises a step provided between two adjacent connection grooves among the plurality of holder connection grooves.

12. The assembly-type motor fixing structure of claim 1, wherein at least one of the upper holder, the lower holder, and the main holder comprises aluminum.

13. The assembly-type motor fixing structure of claim 1, wherein the main holder and the motor are formed integrally as one body.

14. The assembly-type motor fixing structure of claim 1, wherein the main holder and the lower holder are formed integrally as one body.

15. The assembly-type motor fixing structure of claim 1, wherein the wearable device is a walking assist device.

16. The assembly-type motor fixing structure of claim 1, wherein the upper frame and lower frame are configured to support a leg of the user of the wearable device.
